(19) United States
(12) Patent Application Publication
(10) Pub. No.: US 2008/0212423 A1
(43) Pub. Date: Sep. 4, 2008

(54) Method of Ensuring Reproduction Compatibility of Information Recording Medium, and Recording and/or Reproducing Apparatus and Information Recording Medium Therefor

(76) Inventors: Sung-Hee Hwang, Suwon-si (KR); Kyung-Geun Lee, Seongnam-si (KR)

Correspondence Address: STEIN, MCEWEN & BUI, LLP, 1400 EYE STREET, NW, SUITE 300, WASHINGTON, DC, 20005, US

(21) Appl. No.: 12/064,359

(22) PCT Filed: Aug. 24, 2006
(86) PCT No.: PCT/KR2006/003326

§ 371 Date: Feb. 21, 2008

(30) Foreign Application Priority Data
Aug. 24, 2005 (KR) 10-2005-0078026

(51) Int. Cl. G11B 5/09

(52) U.S. Cl. 369/47.14

(57) ABSTRACT

A method of effectively ensuring a reproduction compatibility of an information recording medium, a recording/reproducing apparatus performing a write/read operation to effectively ensure the reproduction compatibility, and the information recording medium, the information recording medium having a plurality of areas, wherein a usage order of the areas is determined according to a location of data stored in a user data area of the information recording medium, and data is recorded in the plurality of areas based on the determined usage order. Accordingly, it is possible to effectively ensure the reproduction compatibility of the information recording medium.

### CROSS-REFERENCE TO RELATED APPLICATIONS

This application claims the benefit of PCT International Patent Application No. PCT/KR2006/003326, filed Aug. 24, 2006, and Korean Patent Application No. 2005-78026, filed Aug. 24, 2005, in the Korean Intellectual Property Office, the disclosures of which are incorporated herein by reference.

### BACKGROUND OF THE INVENTION

1. Field of the Invention

Aspects of the present invention relate to a method of ensuring the reproduction compatibility of an information recording medium, a recording and/or reproducing apparatus and an information recording medium therefor.

2. Description of the Related Art

Generally, data recording and/or reproducing to/from a recording optical disc having a plurality of tracks is performed by reproducing a physical address stored on the disc in the form of a wobble in order to detect the physical address for data recoding and/or reproducing while performing tracking using a push-pull signal to access a location of the disc where data is recorded or reproduced. Since it is difficult to ensure that data is recorded on a physical area before a location that data is to be recorded on or reproduced from, tracking is generally performed on the recording optical disc by using the push-pull signal.

A recording optical disc may be any of a variety of media. When the order of the medium of a recording surface is changed, the characteristics of the push-pull signal are changed accordingly.

FIG. 1 is a reference diagram illustrating the characteristics of a push-pull signal for two different media before and after data recording. Referring to FIG. 1, in the case of a high-to-low medium, the reflexibility before data recording is greater than that after data recording, and the characteristics of the push-pull signal are similar before and after data recording. In the case of a low-to-high medium, the reflexibility before data recording is less than that after data recording, and the characteristics of the push-pull signal are different before and after data recording. As described above, the characteristics of the push-pull signal may be changed according to the types or the order of media of a recording disc.

In general, when establishing a standard for data recording and/or reproducing, the permitted limit of a push-pull signal before and after data recording according to the characteristics of the disc is specified in the standard. By specifying the permitted limit of the push-pull signal before and after data recording in the standard, a drive system for data recording and/or reproducing on the disc can be manufactured according to the specified permitted limit of the push-pull signal. Accordingly, it is possible to stably perform tracking on the disc for data recording and/or reproducing by using the push-pull signal.

A standard A for the high-to-low media illustrated in FIG. 1 is prescribed based on the fact that the characteristics of the push-pull signal are similar before and after data recording. Thus, a drive system A for the high-to-low media is manufactured according to the standard for the push-pull signal before and after data recording, which is specified in the standard A, and tracking is performed accordingly for data recording and/or reproducing on the disc.

Similarly, development of the low-to-high media, illustrated in FIG. 1, in which the characteristics of the push-pull signal are different before and after data recording, triggers development of a standard B and a drive system B based on the standard B. The standard B specifies a standard for the push-pull signal before data recording that is not compatible with the standard A.

When both the drive system A according to the standard A and the drive system B according to the standard B are put on the market, a user may feel an inconvenience since they are not compatible with each other. Accordingly, there is a growing need to develop methods of ensuring compatibility in terms of the reproducibility of media (for example, when a low-to-high medium subject to the standard for the push-pull signal before data recording that is different from the standard for the push-pull signal according to the standard A is loaded into the drive system A).

### SUMMARY OF THE INVENTION

Aspects of the present invention provide a method of ensuring the reproduction compatibility of an information recording medium, a recording and/or reproducing apparatus performing a write and/or read operation to effectively ensure the reproduction compatibility of an information recording medium, and an information recording medium therefor.

According to an aspect of the arranged invention, there is provided an information recording medium with a plurality of areas, wherein usage order of the areas is determined according to a location of data recorded in a user data area arranged in the information recording medium, and data is recorded in the areas in the determined usage order.

The areas may comprise at least one of a replacement area for replacement of the data recorded in the user data area, and a disc management information area for disc management of the information recording medium.

The usage order may be determined to minimize blank areas to be padded with padding data to ensure the reproduction compatibility of the information recording medium.

Blank areas of at least one of the areas may be padded with padding data when the reproduction compatibility of the information recording medium is required.

According to another aspect of the present invention, there is provided an information recording medium having a plurality of areas, wherein at least one block recorded in at least one area of the areas is moved to and recorded in at least another area in order to ensure the reproduction compatibility of the information recording medium.

The areas may include at least one of a replacement area for replacement of data recorded in a user data area arranged in the information recording medium, and a disc management information area for disc management of the information recording medium.

When the areas are replacement areas, the block may be a replacement block replacing a data block recorded in the user data area, and replacement information may be changed to reflect movement of the replacement block is further recorded in the information recording medium.

The characteristics of a reproduction signal in an area containing data of the information recording medium may be different from those of a reproduction signal in a blank area of the information recording medium.

The characteristics of the reproduction signal may be the same as those of a push-pull signal.

According to another aspect of the present invention, there is provided a recording and/or reproducing apparatus which records data on or reproduces data from an information recording medium with a plurality of areas, the apparatus comprising a writing and/or reading unit recording data on or reading data from the information recording medium; and a controller determining a usage order of the areas according to a location of data recorded in a user data area arranged in the information recording medium, and controlling the writing and/or reading unit to record data in the areas in the determined usage order.

According to another aspect of the present invention, there is provided a recording and/or reproducing apparatus which records data on or reproduces data from an information recording medium with a plurality of areas, the apparatus including a writing and/or reading unit recording data on or reading data from the information recording medium; and a controller controlling the writing and/or reading unit to move at least one block recorded in at least one area of the areas to at least another area and record the at least one bock in the at least another area in order to ensure the reproduction compatibility of the information recording medium.

According to another aspect of the present invention, there is provided a recording and/or reproducing apparatus which ensures the reproduction compatibility of an information recording medium with a plurality of areas, the apparatus including a writing and/or reading unit recording data on and/or reading data from the information recording medium; and a controller controlling the writing and/or reading unit to record data on or read data from the information recording medium.

The controller may receive a command to ensure the reproduction compatibility of the information recording medium from an external control device, or generates the command; and controls the writing and/or reading unit to move at least one replacement block recorded in at least one replacement area of the information recording medium to at least another replacement area in response to the command, record padding data in blank areas of the replacement area so that areas containing data are continuously located, and record replacement information changed to reflect movement of the replacement block.

According to another aspect of the present invention, there is provided a method of ensuring the reproduction compatibility of an information recording medium with a plurality of areas, the method comprising determining a usage order of the areas according to a location of data recorded in a user data area arranged in the information recording medium; and recording data in the areas in the determined usage order.

According to another aspect of the present invention, there is provided a method of ensuring the reproduction compatibility of an information recording medium with a plurality of areas, the method comprising moving at least one block recorded in at least one area of the areas to at least another area in order to ensure the reproduction compatibility of the information recording medium.

According to another aspect of the present invention, there is provided a recording and/or reproducing method for ensuring the reproduction compatibility of an information recording medium with a plurality of areas, the method comprising receiving a command to ensure the reproduction compatibility of the information recording medium from an external control device, or generating the command; moving at least one replacement block recorded in at least one replacement area of the information recording medium to another replacement area in response to the command; recording padding data into blank areas of the replacement area so that areas containing data are continuously located; and recording replacement information changed to reflect movement of the replacement block in the information recording medium.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a reference diagram illustrating characteristics of a push-pull signal for two different media before and after data recording;

FIG. 2 is a schematic block diagram of a recording and/or reproducing apparatus capable of ensuring the reproduction compatibility of an information recording medium according to an embodiment of the present invention;

FIG. 3 is a detailed block diagram of the recording and/or reproducing apparatus illustrated in FIG. 2;

FIG. 4A illustrates an example of a layout of a single recording layer disc according to an embodiment of the present invention;

FIG. 4B illustrates an example of a layout of a dual recording layer disc according to an embodiment of the present invention;

FIG. 5A illustrates an example of a layout of a single recording layer disc according to another embodiment of the present invention;

FIG. 5B illustrates an example of a layout of a dual recording layer disc according to another embodiment of the present invention;

FIG. 6A is a reference diagram illustrating an example of a usage order of a plurality of replacement areas in the disc layout of FIG. 4A for ensuring the reproduction compatibility of disc;

FIG. 6B illustrates a state of a disc having the disc layout of FIG. 6A after padding data into blank areas;

FIG. 7A is a reference diagram illustrating a usage order of a plurality of replacement areas in the disc layout of FIG. 4B for ensuring the reproduction compatibility of a disc according to an embodiment of the present invention;

FIG. 7B illustrates a state of a disc having the disc layout of FIG. 7A after padding data into blank areas;

FIG. 8A is a reference diagram illustrating an example of a method of ensuring the reproduction compatibility of a disc in the disc layout of FIG. 4B according to another embodiment of the present invention;

FIG. 8B illustrates a state of a disc having the disc layout of FIG. 8A after padding data into blank areas;

FIG. 9A is a reference diagram illustrating an example of a usage order of a plurality of replacement areas in the disc layout of FIG. 4A for ensuring the reproduction compatibility of a disc according to another embodiment of the present invention;

FIG. 9B illustrates a state of a disc having the disc layout of FIG. 9A after moving stored replacement blocks to another area for ensuring the reproduction compatibility of a disc according to another embodiment of the present invention;

FIG. 10 is a flowchart illustrating a method of ensuring the reproduction compatibility of an information recording medium according to an embodiment of the present invention;

FIG. 11 is a flowchart illustrating a method of ensuring the reproduction compatibility of an information recording medium according to another embodiment of the present invention; and

FIG. 12 is a flowchart illustrating the method of FIG. 11 in more detail.

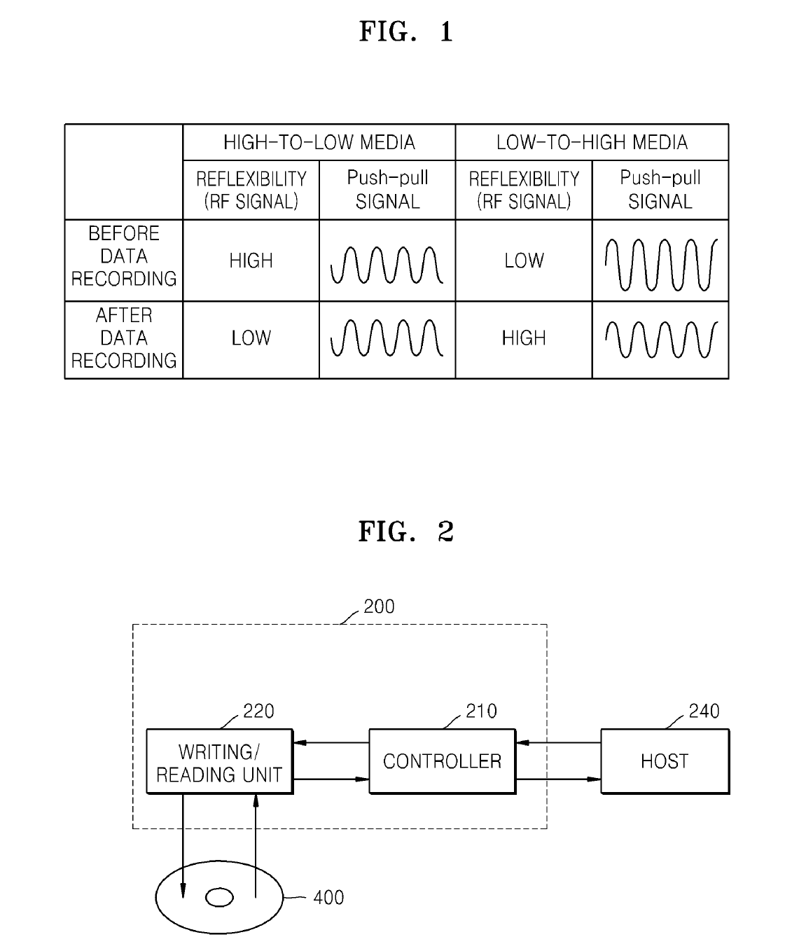

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

A push-pull signal before recording data on a low-to-high medium according to a first standard is different from a push-pull signal before recording data on a low-to-high medium according to a second standard. Thus, before data recording, there is no reproduction compatibility between the low-to-high medium according to the first standard and the low-to-high medium according to the second standard.

However, the push-pull signal after recording data on the low-to-high medium according to the first standard is similar to the push-pull signal after recording data on the low-to-high medium according to the second standard. Thus, after data recording, there is reproduction compatibility between the low-to-high medium according to the first standard and the low-to-high medium according to the second standard.

Accordingly, a method has been developed for recording data in a blank area of a high-to-low medium according to the first standard so that a drive system according to the second standard may reproduce the data from the high-to-low medium according to the first standard. However, a large amount of time is needed to record the data in the blank area of the high-to-low medium according to the first standard.

For example, when data is recorded along the innermost and outermost circumferences of a disc, a large amount of time is needed to record data on all blank areas of the disc to ensure the reproduction compatibility of the disc. Thus, a method of effectively using and managing a medium to minimize time used to fill the medium with data is beneficial when ensuring the reproduction compatibility of the medium.

Accordingly, aspects of the present invention minimize blank areas of an information recording medium by effectively using and managing each area of the information recording medium in order to minimize a time needed to fill the information recording medium with data to ensure the reproduction compatibility of the information recording medium.

In general, a management information area for disc management (such as defect management or recording and/or reproducing management information) is allocated to the inner and/or outer circumference of a disc type optical recording medium. Furthermore, an area between the inner and outer circumferences is used to record user data therein. In this case, if a plurality of management information areas is allocated to the information recording medium, the usage of the plurality of the areas is defined to minimize blank areas when recording data on the blank areas to ensure the reproduction compatibility of the information recording medium.

For example, when a disc management information area for the overall disc recording management (such as a defect management area for defect management, a replacement area for defect replacement or a logical overwrite, and a recording and/or reproducing management area for recording and/or reproducing management) is allocated to the inner and outer circumferences of the disc and when user data is used or recorded in a direction from the inner circumference to the outer circumference, the usages of the plurality of the areas may be defined to use the disc management information area allocated to the inner circumference before the disc management information area allocated to the outer circumference. In contrast, when the user data is used or recorded in a direction from the outer circumference to the inner circumference, the disc management information area allocated to the outer circumference may be used prior to the disc management information area allocated to the inner circumference. In this way, it is possible to minimize blank areas to be filled with data to ensure the reproduction compatibility of the disc with a drive system subject to a different standard.

As another example, when the disc management information area is allocated to a plurality of areas of the disc, if disc management information is recorded in at least one area, the recorded disc management information may be further recorded in at least another area. As a result, the blank areas to be filled with data to ensure the reproduction compatibility of the disc with a drive system subject to a different standard are minimized.

FIG. 2 is a schematic diagram of a recording and/or reproducing apparatus 200 capable of ensuring the reproduction compatibility of an information recording medium 400 according to an embodiment of the present invention. Referring to FIG. 2, the recording and/or reproducing apparatus 200 is an apparatus that can record and/or reproduce data, and includes a writing and/or reading unit 220 and a controller 210. Under the control of the controller 210, the writing and/or reading unit 220 records data on the information recording medium 400, and/or reads data from the information recording medium 400 to reproduce the data. In response to a command from a host 240, the controller 210 controls the writing and/or reading unit 220 to record data on or to read data from the information recording medium 400, or processes the data read by the writing and/or reading unit 220 in order to obtain valid data. Although FIG. 2 illustrates that the host 240 is located outside the recording and/or reproducing apparatus 200, aspects of the present invention are not limited thereto. For example, the host 240 may be located in the recording and/or reproducing apparatus 200.

In particular, according to the present embodiment, the controller 210 controls the writing and/or reading unit 220 to use a plurality of areas arranged in the information recording medium 400 or record a plurality of pieces of information, stored in at least one area, to another area in order to minimize blank areas, thereby ensuring the reproduction compatibility of the information recording medium 400.

FIG. 3 is a detailed block diagram of the recording and/or reproducing apparatus 200 of FIG. 2. Referring to FIG. 3, the recording and/or reproducing apparatus 200 includes the writing and/or reading unit 220, which is a pickup. The information recording medium 400 is loaded into the pickup 220. Furthermore, the controller 210 of the recording and/or reproducing apparatus 200 includes a host interface (I/F) 211, a digital signal processor (DSP) 212, a radio-frequency amplifier (RF AMP) 213, a servo 214, and a system controller 215.

The host I/F 211 receives a read/write command from the host 240, and transmits the read/write command to the system controller 215. In particular, according to the present embodiment, the host I/F 211 is capable of receiving a reproduction compatibility ensuring command from the host 240 to perform processing for ensuring the reproduction compatibility of the information recording medium 400.

During a write operation, the system controller 215 receives a write command from the host I/F 211, and controls the pickup 220 to perform initialization for data recording and to record data on the information recording medium 400 according to the write command. Specifically, the system controller 215 controls the usage order of a plurality of disc management areas or a plurality of replacement areas arranged in the information recording medium 400 in order to minimize blank areas to be filled with data to ensure the reproduction compatibility of the information recording medium 400.

Also, when the disc management information is recorded in more than one disc management area, the system controller 215 controls the pickup 220 to move the recorded disc management information to another disc management area.

Furthermore, when replacement blocks are recorded in more than one replacement area, the system controller 215 controls the pickup 220 to move the recorded replacement blocks to another replacement area. In this case, since the addresses of the replacement blocks are changed by moving the replacement blocks to another replacement area, the system controller 215 may further control the pickup 220 to update a replacement entry representing the state of replacement and record the replacement entry in a replacement information area. As described above, information recorded in an area may be moved to another area in response to a command to ensure the reproduction compatibility of the information recording medium 400 that is received from the host 240 or generated according to a policy of the recording and/or reproducing apparatus 200.

The DSP 212 generates an error correction code (ECC) by adding additional data (such as parity) to data to be recorded, which is received from the host I/F 211, and performing ECC encoding thereon for error correction. The DSP 212 then modulates the encoding result according to a predetermined method. The RF AMP 213 converts the data from the DSP 212 into an RF signal. The pickup 250 records the RF signal from the RF AMP 213 onto the information recording medium 400. The servo 214 receives a command for servo control from the system controller 215 and performs servo control on the pickup 250.

During a read operation, the host I/F 211 receives a read command from the host 240. The system controller 215 controls the pickup 220 to perform initialization for data reading and to read data in response to the read command.

Specifically, the pickup 250 irradiates a laser beam onto the information recording medium 400, and outputs an optical signal obtained from a laser beam reflected from the information recording medium 400. The RF AMP 213 converts the optical signal from the pickup 220 into an RF signal, provides the DSP 212 with modulated data obtained from the RF signal, and provides the servo 214 with a servo signal for controlling from the RF signal. The DSP 212 demodulates the modulated data, performs ECC decoding on the demodulated data, and outputs the decoding result.

The servo 214 receives the servo signal from the RF AMP 213 and the command for servo control from the system controller 215, and performs servo control on the pickup 220. The host I/F 211 transmits the data from the DSP 212 to the host 240.

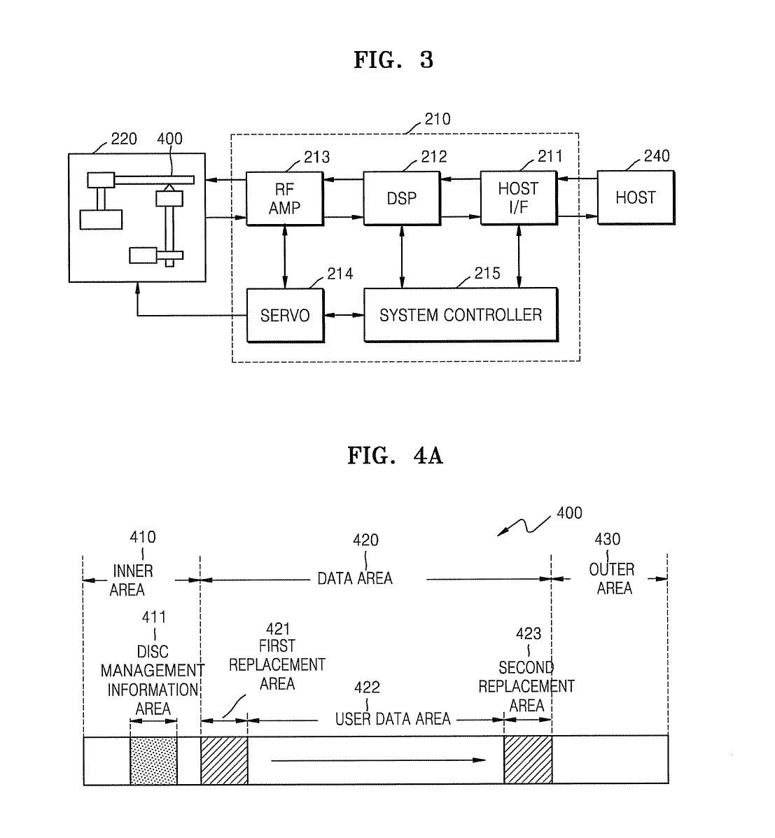

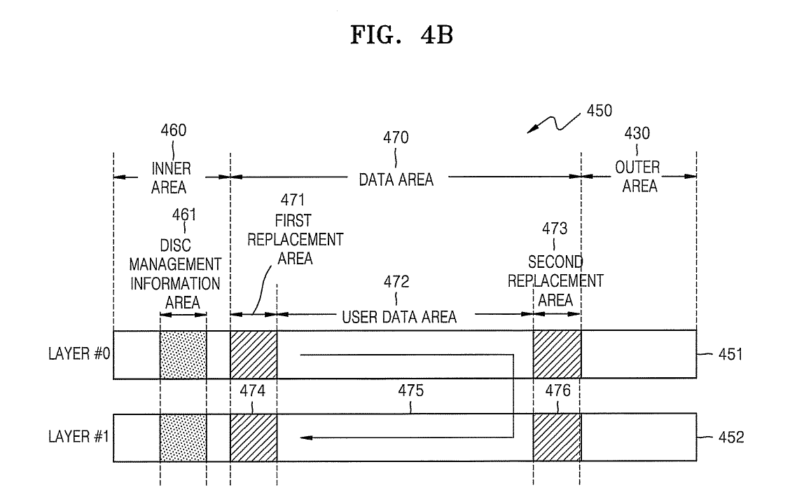

FIG. 4A illustrates an example of a layout of a single recording layer disc 400 according to an embodiment of the present invention. Referring to FIG. 4A, the disc 400 includes an inner area 410 allocated to the inner circumference of the disc 400, an outer area 430 allocated to the outer circumference of the disc 400, and a data area 420 arranged between the inner area 410 and the outer area 430.

The inner area 410 includes a disc management information area 411 for storing disc management information (such as replacement information and recoding management information).

The disc management information may include replacement information such as a replacement entry representing a state of a replacement due to a defect or a logical overwrite. Furthermore, the disc management information may include recording management information regarding a state of user data for recording management (e.g., whether the user data is recorded on a disc in a sequential recording mode in which the disc is divided into two or more areas and data is continuously recorded in the two or more areas, or recorded in a random recording mode). The recording management information distinguishes an area containing data and an area containing no data and allows a recordable area to be recognized.

FIG. 4A illustrates that the disc management information area 411 is provided only in the inner area 410. However, it is understood that aspects of the present invention are not limited thereto. That is, the disc management information area 411 may be arranged in the outer area 430, both the inner area 410 and the outer area 430, or the data area 420. Also, the disc 400 may include a plurality of disc management information areas 411.

Although not shown in FIG. 4A, a disc identification area storing identification information of the disc 400 and a test area for detecting proper recording power may further be allocated to the inner area 410.

The data area 420 includes a first replacement area 421, a user data area 422, and a second replacement area 423. The user data area 422 is used to store user data, and the first and second replacement areas 421 and 423 are used to store replacement data for a defect contained in data stored in the user data area 422 or replacement data for performing a logical overwrite on the data stored in the user data area 422. The logical overwrite is a process in which a defect management method is used to update data stored in a write-once recording medium. That is, the logical overwrite is a method of recording data by recording replacement data for updating already recorded original data in a different location or a different area on a medium and managing information regarding the addresses of the original data and the replacement data. Accordingly, a host 240 can recognize the replacement data as if the original data were updated at the same logical address. A plurality of such replacement areas 421 and 423 may be arranged on the disc 400.

When a first standard for a push-pull signal for the disc 400 after data recording is compatible with a second standard for the push-pull signal after recording data on a disc according to a different standard, but the first standard for the push-pull signal for the disc 400 before data recording is not compatible with the second standard for the push-pull signal before recording data on the disc according to the different standard, a drive system for the disc 400 manages the disc 400 to minimize blank areas of the disc 400. Specifically, the drive system for the disc 400 fills the disc 400 with padding data in order to allow a drive system for the disc according to the different standard to reproduce data from the disc 400. That is, the usage order of a plurality of areas of the disc 400 (e.g., disc management information areas or replacement areas) is determined to minimize the blank areas of the disc 400, and the plurality of the areas are used in the determined usage order.

FIG. 4B illustrates an example of a layout of a dual recording layer disc 450 according to an embodiment of the present invention. Referring to FIG. 4B, the disc 450 includes two recording layers 451 and 452 (i.e., a layer #0 451 and a layer #1 452).

Each of the layer #0 451 and the layer #1 452 includes an inner area 460, a data area 470, and an outer area 480. The inner area 460 includes a disc management information area 461, and the data area 470 includes a first replacement area 471, a user data area 472, and a second replacement area 473.

Like in the single recording layer disc 400 illustrated in FIG. 4A, in the case of the dual recording layer disc 450, when a first standard for a push-pull signal for the disc 450 after data recording is compatible with a second standard for the push-pull signal after recording data on a disc according to a different standard, but the first standard for the push-pull signal for the disc 450 before data recording is not compatible with the second standard for the push-pull signal before recording data on the disc according to the different standard, a drive system for the disc 450 manages the disc 450 to minimize blank areas of the disc 450. Specifically, the drive system for the disc 450 fills the disc 450 with padding data in order to allow a drive system for the disc according to the different standard to reproduce data from the disc 450. That is, the usage order of a plurality of areas of the disc 450 (e.g., disc management information areas or replacement areas) is determined to minimize the blank areas of the disc 450, and the plurality of the areas are used in the determined usage order.

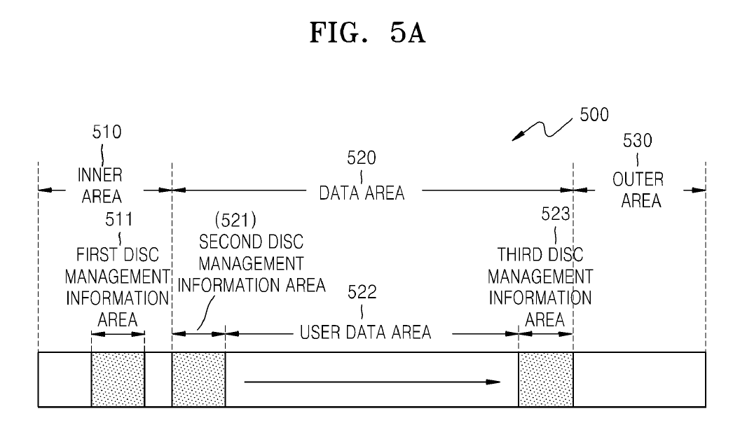

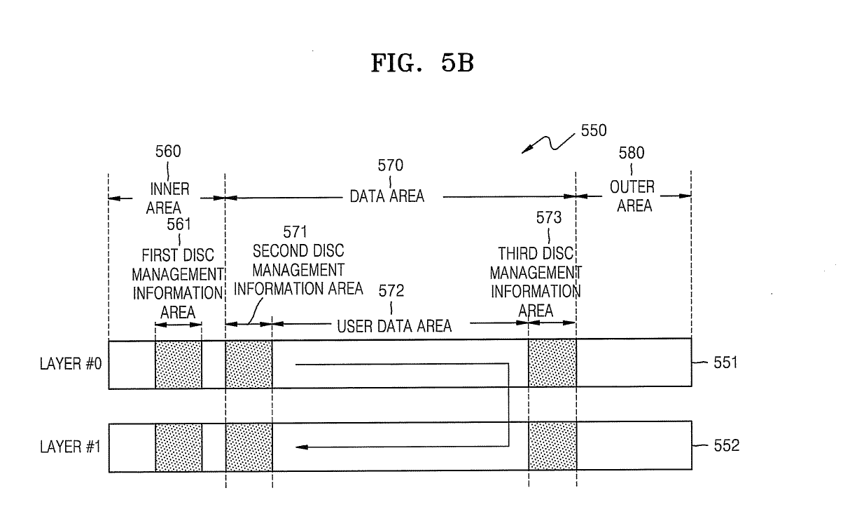

FIG. 5A illustrates an example of a layout of a single recording layer disc 500 according to another embodiment of the present invention. Referring to FIG. 5A, the disc 500 includes an inner area 510, a data area 520, and an outer area 530. The inner area 510 includes a first disc management information area 511, and the data area 520 includes a second disc management information area 521, a user data area 522, and a third disc management information area 523.

FIG. 5B illustrates an example of a layout of a dual recording layer disc 550 according to another embodiment of the present invention. Referring to FIG. 5B, the disc 550 includes two recording layers 551 and 552 (i.e., a layer # 0 551 and a layer #1 552). Each of the layer # 0 551 and the layer #1 552 includes an inner area 560, a data area 570, and an outer area 580. The inner area 560 includes a first disc management information area 561, and the data area 570 includes a second disc management information area 571, a user data area 572, and a third disc management information area 573.

The functions of the disc management information areas 511, 521, 561, and 571 illustrated in FIGS. 5A and 5B are the same as that of the disc management information area 411 illustrated FIG. 4A.

In the case of the discs 500 and 550 illustrated in FIGS. 5A and 5B, respectively, the usage order of a plurality of disc management information areas is determined to minimize blank areas to ensure the reproduction compatibility of the discs 500 and 550, and the disc management information areas are used in the determined usage order.

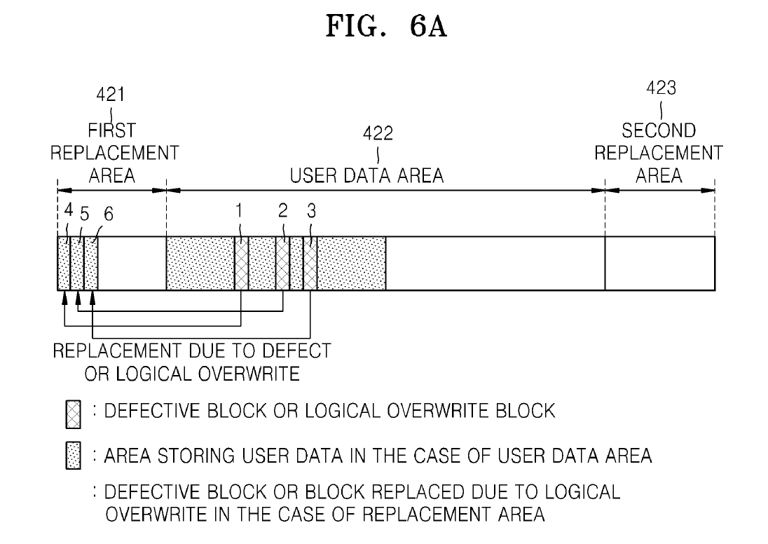

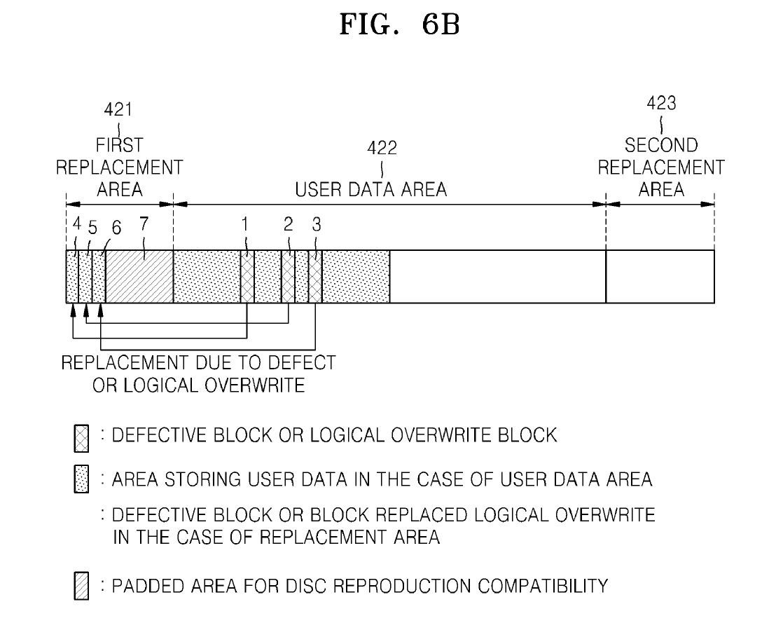

FIG. 6A is a reference diagram illustrating an example of a usage order of the first and second replacement areas 421 and 423 in the disc layout of FIG. 4A. When user data is recorded in the user data area 422 in a direction from an inner circumference to an outer circumference, the usage order is determined to first record a replacement block in the first replacement area 421 allocated to the inner circumference. Accordingly, the second replacement area 423 allocated to the outer circumference is used after the first replacement area 421 allocated to the inner circumference is filled with data. The replacement block is used to replace a defective block in the user data area 422 or is used to perform a logical overwrite.

Referring to FIG. 6A, about half the user data area 422 on a side thereof closer to the inner circumference is filled with user data, and thus, replacement blocks are recorded in the first replacement area 421 allocated to the inner circumference. That is, a replacement block 4 replacing a block 1, a replacement block 5 replacing a block 2, and a replacement block 6 replacing a block 3 are recorded in the first replacement area 421.

FIG. 6B illustrates a state of a disc having the disc layout of FIG. 6A after padding data into blank areas. When filling of padding data into blank areas is needed to ensure the reproduction compatibility of the disc having the disc layout of FIG. 6A, it is sufficient to record padding data in only a blank area 7 of the first replacement area 421 as illustrated in FIG. 6B, thereby minimizing a space of the disc in which the padding data is to be recorded. The padding data is recorded to simply fill the blank area 7 with data, and thus need not have a specific value. That is, the padding data may be predetermined meaningless data.

Since user data is not recorded in half the user data area 422 on the side thereof closer to the outer circumference, a drive system need not access the unrecorded half of the user data area 422. Although data is not recorded in the unrecorded half of the user data area 422, a reproduction compatibility problem does not occur therein.

If user data is recorded on about half of the user data area 422 starting from the side thereof closer to the inner circumference, when a replacement block is recorded in the second replacement area 423, the first replacement area 421 and the half the user data area 422 contain no data, thus increasing a space of the disc to be filled with the padding data to ensure the reproduction compatibility. In this case, a large amount of time is needed to record the padding data to ensure the reproduction compatibility.

As described above, when an information recording medium in which blank areas are filled with data (i.e., padding data) is loaded into a recording and/or reproducing apparatus subject to a different standard, a blank area is not present from a start address of the first replacement area 421 to a last recorded address of the user data area 422. Thus, recorded data can be reproduced without a tracking problem. Also, when the information recording medium is loaded again into a recording and/or reproducing apparatus that first records data thereon, data can further be recorded on the information recording medium by using blank areas of the user data area and an unused replacement area.

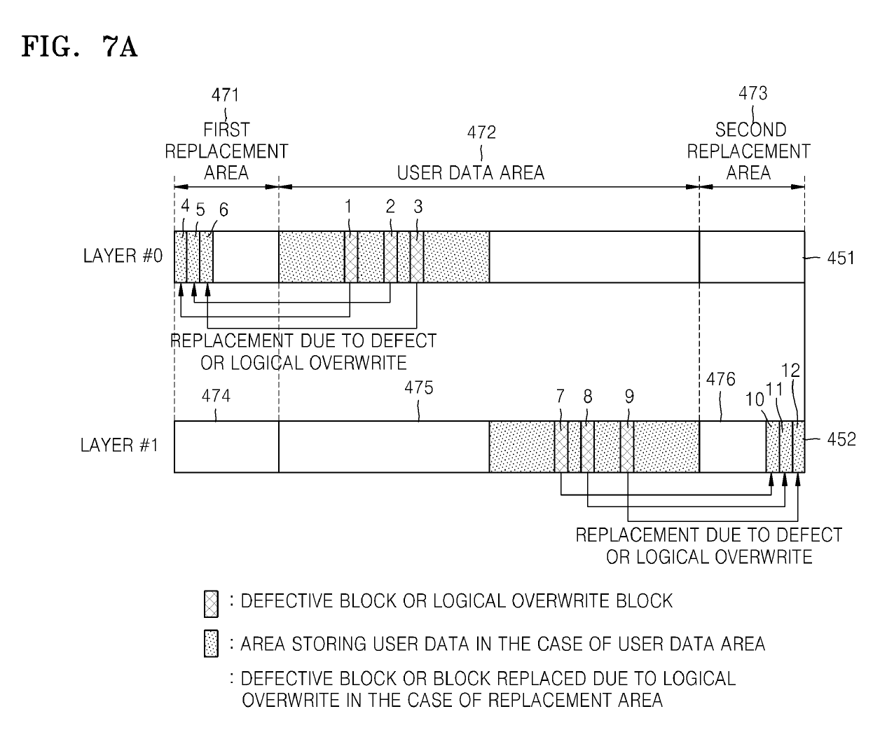

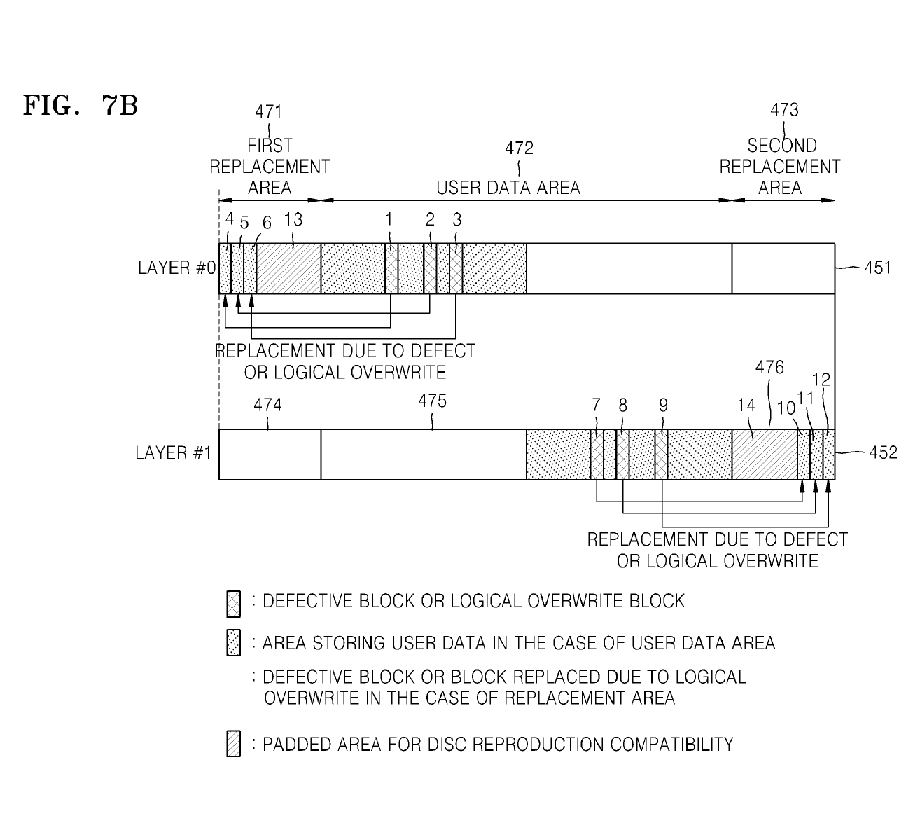

FIG. 7A is a reference diagram illustrating an example of a usage order of the first and second replacement areas 471 and 473 in the the disc layout of FIG. 4B. Referring to FIG. 7A, user data is recorded on the recording layer #0 451 from the inner circumference to the outer circumference and recorded on the layer #1 452 from the outer circumference to the inner circumference. In this case, the usage order of replacement areas is determined such that a replacement block for layer #0 451 that will replace a defective block in the user data area 472 or be used for a logical overwrite is first recorded in the first replacement area 471 allocated to the inner circumference in the layer #0 451. Similarly, a replacement block for layer #1 452 that will replace a defective block in the user data area 475 or be used for a logical overwrite is first recorded in the second replacement area 476 allocated to the outer circumference in the layer #1 452.

Specifically, in layer #0 451 replacement blocks are recorded in the first replacement area 471 allocated to the inner circumference, since half the user data area 472 in the layer #0 451 closer to the inner circumference is recorded with the user data starting from a side thereof closer to the inner circumference. That is, a replacement block 4 replacing a block 1, a replacement block 5 replacing a block 2, and a replacement block 6 replacing a block 3 are recorded in the first replacement area 471.

In layer #1 452, replacement blocks are recorded in the second replacement area 476 allocated to the outer circumference, since half the, user data area 475 in the layer #1 452 closer to the outer circumference is recorded with the user data starting from a side thereof closer to the outer circumference. That is, a replacement block 10 replacing a block 7, a replacement block 11 replacing a block 8, and a replacement block 12 replacing a block 9 are recorded in the second replacement area 476.

FIG. 7B illustrates a state of a disc having the disc layout of FIG. 7A after padding data into blank areas. When padding data into blank areas is needed to ensure the reproduction compatibility of the disc having the disc layout of FIG. 7A, padding data is recorded in only a blank area 13 of the first replacement area 471 in the layer #0 451, and in only a blank area 14 of the second replacement area 476 in the layer #1 452, as illustrated in FIG. 7B, thereby minimizing a space of the disc in which the padding data is to be recorded.

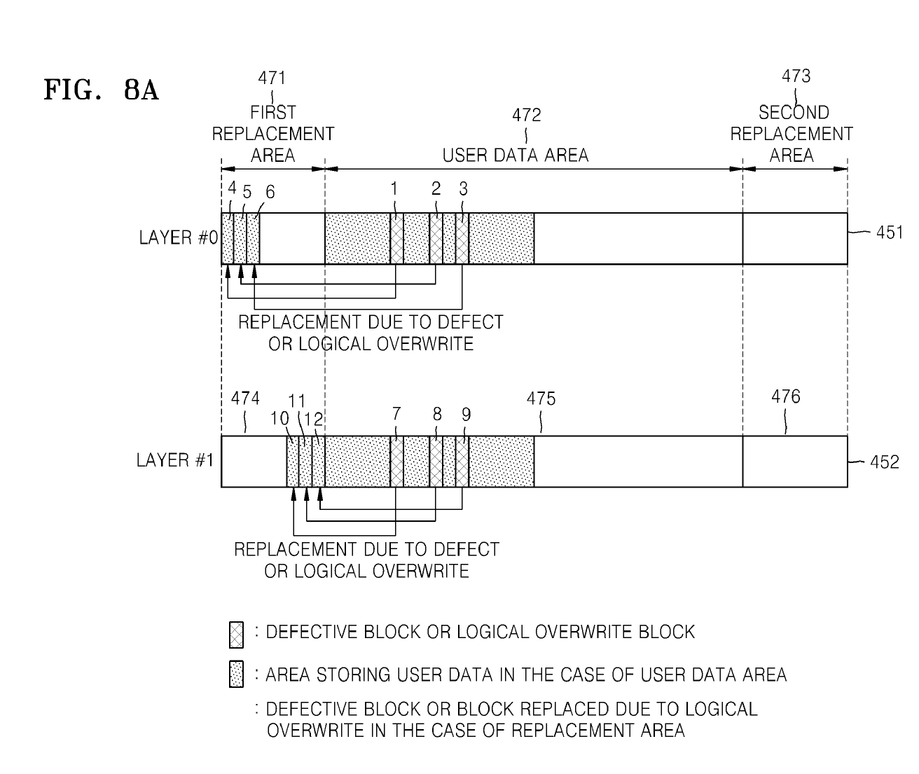

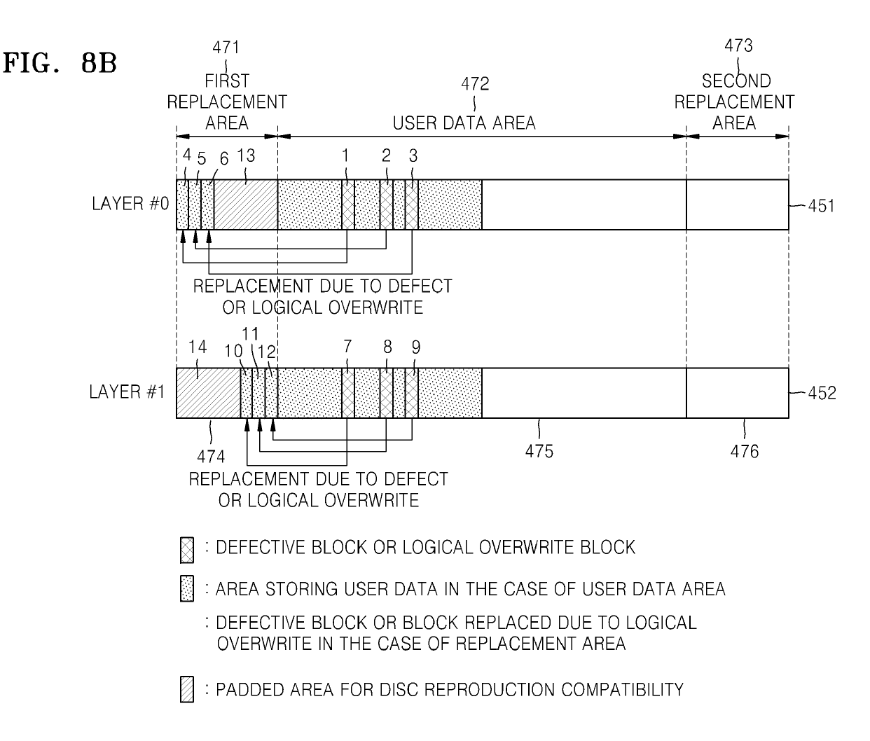

FIG. 8A is a reference diagram illustrating an example of a usage order of the first and second replacement areas 471 and 473 of the disc having the layout of FIG. 4B according to another embodiment of the present invention. Referring to FIG. 8A, user data is recorded in both the layer #0 451 and the layer #1 452 from the inner circumference to the outer circumference. In this case, the usage order of replacement areas is determined such that a replacement block replacing a defective block in the user data area 472 or a replacement block due to a logical overwrite is recorded in the first replacement area 471 allocated to the inner circumference in the layer #0 451. Similarly, a replacement block replacing a defective block in the user data area 475 or a replacement block due to a logical overwrite is also recorded in the first replacement area 474 allocated to the inner circumference in the layer #1 452.

Specifically, replacement blocks are recorded in the first replacement area 471 allocated to the inner circumference, since half the user data area 472 of the layer #0 451 closer to the inner circumference is filled with the user data and the user data is recorded in the user data area 472 starting from the side thereof closer to the inner circumference. That is, a replacement block 4 replacing a block 1, a replacement block 5 replacing a block 2, and a replacement block 6 replacing a block 3 are recorded in the first replacement area 471.

Furthermore, replacement blocks are recorded in the first replacement area 474 allocated to the inner circumference, since half the user data area 475 of the layer #1 452 closer to the inner circumference is filled with the user data and the user data is recorded in the user data area 475 starting from the side thereof closer to the inner circumference. That is, a replacement block 10 replacing a block 7, a replacement block 11 replacing a block 8, and a replacement block 12 replacing a block 9 are recorded in the first replacement area 474.

FIG. 8B illustrates a state of a disc having the layout of FIG. 8A after padding data into blank areas. When padding data into blank areas of the disc illustrated in FIG. 8A is needed to ensure the reproduction compatibility of the disc, the padding data is recorded only in a blank area 13 of the first replacement area 471 in the layer #0 451, and in a blank area 14 of the first replacement area 474 in the layer #1 452 as illustrated in FIG. 8B, thereby minimizing a space of the disc to which the padding data is to be recorded.

As described above with reference to FIGS. 6A through 8B, in a single recording layer disc or a dual recording layer disc, when user data is recorded in a user data area starting from a side thereof closer to the inner circumference, a replacement area that is adjacent to the inner circumference is determined to be first used. Similarly, the usage order of a plurality of replacement areas is determined according to the manner in which the user data is recorded in the user data area. As described above, the usage order of a plurality of replacement areas is determined to minimize blank areas to be padded with data in order to ensure the reproduction compatibility of the disc with a drive system subject to a different standard, thereby minimizing a time needed for padding to ensure the reproduction compatibility.

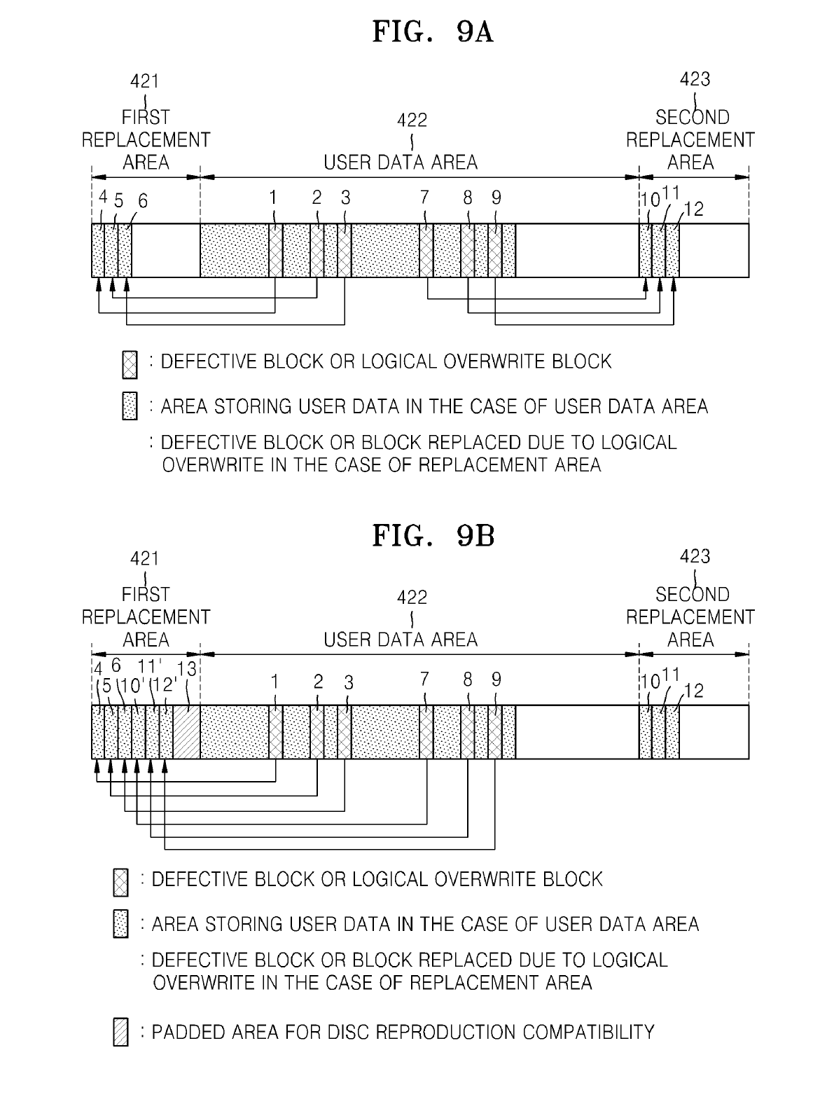

FIG. 9A is a reference diagram illustrating a method of ensuring the reproduction compatibility of a disc having the disc layout of FIG. 4A by moving replacement blocks stored in a replacement area to another replacement area. When a replacement block replacing a defective block in a user data area 422 stored in the disc or replacement blocks due to a logical overwrite are recorded in replacement areas 421 and 423 allocated to the inner and outer circumferences of the disc, it is possible to minimize blank areas padded with data in order to ensure the reproduction compatibility of the disc by moving replacement blocks recorded in one of the replacement areas 423 to another replacement area 421, thereby reducing a time needed for padding.

Referring to FIG. 9A, replacement blocks 4 through 6, which respectively replace blocks 1 through 3 stored in the user data area 422, are recorded in a first replacement area 421. Similarly, replacement blocks 10 through 12, which will respectively replace blocks 7 through 9 stored in the user data area 422, are recorded in a second replacement area 423.

FIG. 9B illustrates a state of a disc having the disc layout of FIG. 9A after moving stored replacement blocks to another area 421 for ensuring the reproduction compatibility of the disc. Referring to FIG. 9B, replacement blocks recorded in the second replacement area 423 (a replacement block 10′ replacing a block 7, a replacement block 11′ replacing a block 8, and a replacement block 12′ replacing a block 9) are moved to the first replacement area 421, and a blank area 13 is filled with padding data.

Replacement blocks stored in a replacement area 423 may be moved to another replacement area 421 in a bundle (as illustrated in FIGS. 9A and 9B) in response to a command to ensure the reproduction compatibility of disc. The command may be received from a controller (such as a host) outside a drive system or given from the drive system when the disc is ejected from the drive system.

Also, when moving replacement blocks stored in a replacement area to another replacement area, the existing replacement information is changed to reflect changed physical addresses of the moved replacement blocks. The replacement information generally includes the original address of the block and the address of the replacement block. The replacement information reflecting a change to the addresses of the replacement blocks due to the movement thereof is recorded in an area for storing replacement information for the disc.

Aspects of the present invention have been described mainly with respect to replacement areas. However, it is understood that aspects of the present invention are not limited thereto. For example, the methods described with reference to FIGS. 6A through 9B are also applicable to a disc management information area allocated to a data area as illustrated in FIGS. 5A and 5B. That is, the usage order of disc management information areas may be determined or disc management information recorded in a disc management information area may be moved to another disc management information area in order to minimize blank areas to ensure the reproduction compatibility of a disc.

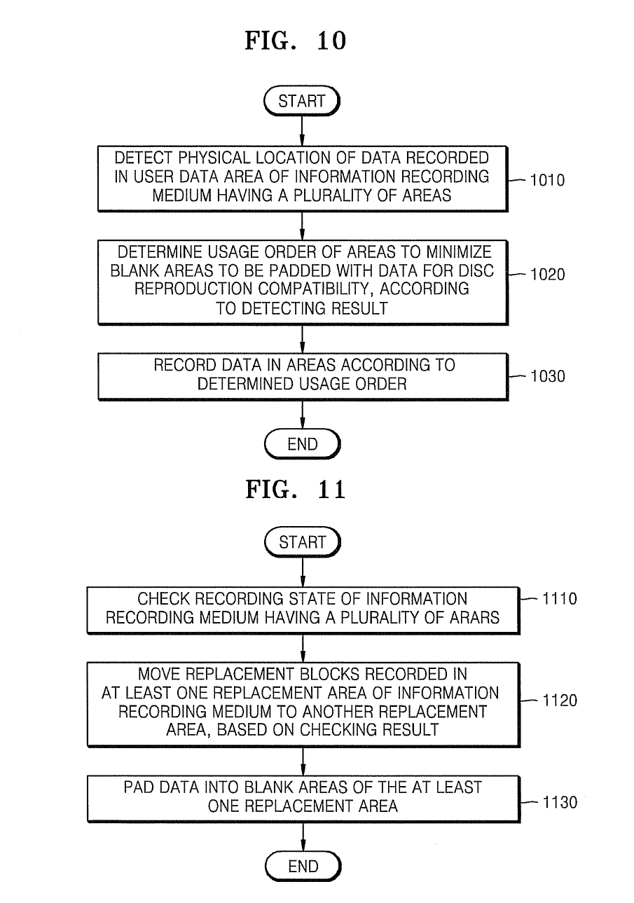

FIG. 10 is a flowchart illustrating a method of ensuring the reproduction compatibility of an information recording medium according to an embodiment of the present invention. Referring to FIGS. 2 and 10, the controller 210 of the recording and/or reproducing apparatus 200 detects a physical location of a user data area of the information recording medium 400 including a plurality of areas in operation 1010.

Based on the detection (operation 1010), the controller 210 determines a usage order of the plurality of the areas in order to minimize blank areas to be padded with data to ensure the reproduction compatibility of the information recording medium 400 in operation 1020. Next, the controller 210 controls the writing and/or reading unit 220 to record data in the plurality of the areas in the determined usage order in operation 1030.

FIG. 11 is a flowchart illustrating a method of ensuring the reproduction compatibility of an information recording medium according to another embodiment of the present invention. Referring to FIGS. 2 and 10, the controller 210 of the recording and/or reproducing apparatus 200 checks a recording state of the information recording medium 400 having a plurality of areas in operation 1110.

Based on this checking (operation 1110), the controller 210 controls the writing and/or reading unit 220 to move replacement blocks recorded in at least one replacement area of the information recording medium 400 to at least another replacement area thereof in operation 1120. Next, the controller 210 controls the writing and/or reading unit 220 to pad predetermined data into areas containing no data of the at least one replacement area in operation 1130.

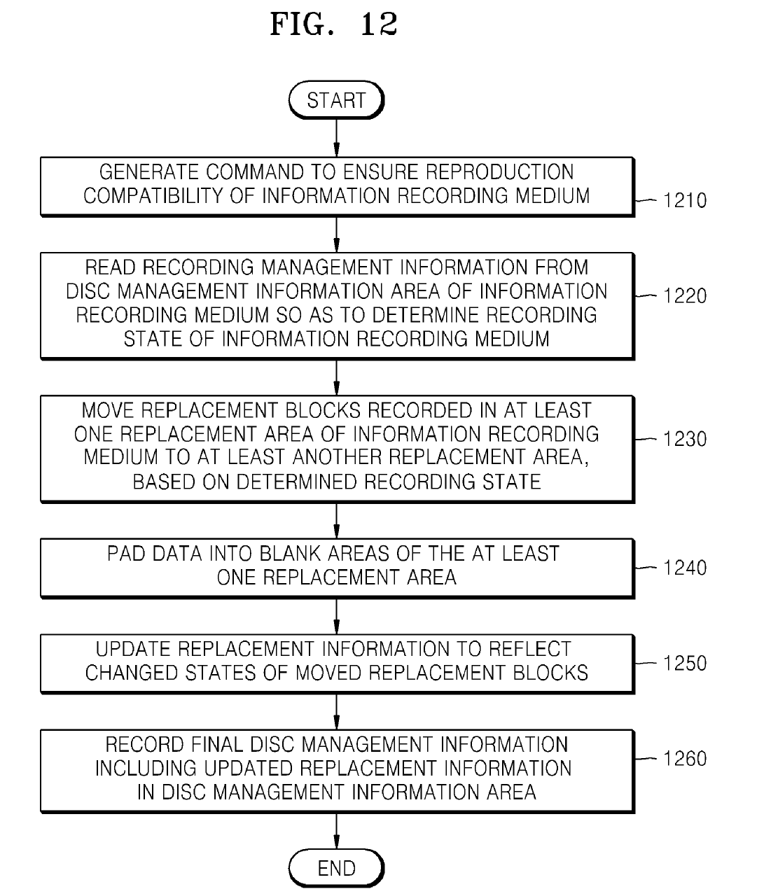

FIG. 12 is a flowchart illustrating the method of FIG. 11 in more detail. Referring to FIG. 12, the controller 210 of the recording and/or reproducing apparatus 200 generates a command to ensure the reproduction compatibility of the information recording medium 400 in operation 1210. The command to ensure the reproduction compatibility of the information recording medium 400 may be generated by the recording and/or reproducing apparatus 200, or may be received from an external host device.

Next, the controller 210 reads recording management information from a disc management information area of the information recording medium 400 so as to determine the recording state of the information recording medium 400 in operation 1220.

Based on the determined recording state (operation 1220), the controller 210 controls the writing and/or reading unit 220 to move replacement blocks recorded in at least one replacement area of the information recording medium 400 to at least another replacement area in operation 1230.

Then, the controller 210 controls the writing and/or reading unit 220 to pad data into blank areas of the at least one replacement area to which the replacement blocks are moved (operation 1230) in operation 1240.

Accordingly, the controller 210 controls the writing and/or reading unit 210 to update replacement information regarding the changed states of the moved replacement blocks in operation 1250, and to record final disc management information including the updated replacement information in a disc management information area in operation 1260.

The above methods of ensuring the reproduction compatibility of an information recording medium according to aspects of the present invention can be embodied as computer-readable code in a computer-readable medium. Here, the computer-readable medium may be any recording apparatus capable of storing data that is read by a computer system, e.g., a read-only memory (ROM), a random access memory (RAM), a compact disc (CD)-ROM, a magnetic tape, a floppy disk, an optical data storage device, and so on. The computer-readable medium can be distributed among computer systems that are interconnected through a network, and the arranged invention may be stored and implemented as computer-readable code in the distributed system. Also, a function program, code, and code segments for the above methods can be easily derived by programmers in the technical field to which aspects of the present invention pertain.

As described above, according to aspects of the present invention, it is possible to minimize blank areas to be filled with data by the drive system B in order to reproduce data from a medium B used in a drive system B by a drive system A subject to a different standard than the drive system B, thereby reducing a time needed to ensure the reproduction compatibility of the medium B. Also, the medium B is still available to the drive system B, since the medium B includes unused areas, excluding the blank areas filled with the padding data to ensure the reproduction compatibility of the drive system A, and a disc management information area.

Although a few embodiments of the present invention have been shown and described, it would be appreciated by those skilled in the art that changes may be made in this embodiment without departing from the principles and spirit of the invention, the scope of which is defined in the claims and their equivalents.

1. An information recording medium comprising:
a user data area to store user data; and
a plurality of other areas,
wherein a usage order of the plurality of other areas is determined according to a location of the user data recorded in the user data area, and data is recorded in the plurality of other areas in the determined usage order.

2. The information recording medium of claim 1, wherein the plurality of other areas comprises:
one or more replacement areas to store replacement data for the user data recorded in the user data area; and/or
one or more disc management information areas for disc management of the information recording medium.

3. The information recording medium of claim 1, wherein the usage order is determined to minimize blank areas to be padded with padding data to ensure a reproduction compatibility of the information recording medium such that the information recording medium having a first standard is compatible with a reproduction device of a second standard, different from the first standard.

4. The information recording medium of claim 1, wherein blank areas of at least one of the other areas are padded with padding data to ensure a reproduction compatibility of the information recording medium such that the information recording medium having a first standard is compatible with a reproduction device of a second standard, different from the first standard.

5. An information recording medium having a plurality of areas, wherein at least one block recorded in at least one first area of the plurality of areas is moved to and recorded in at least one second area of the plurality of areas in order to ensure a reproduction compatibility of the information recording medium, such that the information recording medium having a first standard is compatible with a reproduction device of a second standard, different from the first standard.

6. The information recording medium of claim 5, wherein the plurality of areas comprises:
one or more replacement areas to store replacement data for user data recorded in a user data area of the information recording medium; and/or
one or more disc management information areas for disc management of the information recording medium.

7. The information recording medium of claim 5, wherein:
the plurality of areas comprises a first replacement area and a second replacement area to store replacement data for user data recorded in a user data area of the information recording medium;
a replacement block for replacing a data block recorded in the user data area is moved from the first replacement area to the second replacement area; and
replacement information recorded in the information recording medium is changed to reflect the movement of the replacement block.

8. The information recording medium of claim 1, wherein characteristics of a reproduction signal for an area that has data of the information recording medium is different from characteristics of a reproduction signal for a blank area of the information recording medium.

9. The information recording medium of claim 8, wherein the characteristics of the reproduction signal corresponds to characteristics of a push-pull signal.

10. The information recording medium of claim 5, wherein characteristics of a reproduction signal for an area that has data of the information recording medium are different from characteristics of a reproduction signal for a blank area of the information recording medium.

11. A recording and/or reproducing apparatus to record and/or to reproduce data to/from an information recording medium comprising a user data area to store user data and a plurality of other areas, the apparatus comprising:
a writing and/or reading unit to record and/or to read the data to/from the information recording medium; and
a controller to determine a usage order of the plurality of other areas according to a location of the user data recorded in the user data area, and to control the writing and/or reading unit to record the data in the plurality of other areas in the determined usage order.

12. The apparatus of claim 11, wherein the plurality of other areas comprises:
one or more replacement areas to store replacement data for the user data recorded in the user data area; and/or
one or more disc management information areas for disc management of the information recording medium.

13. The apparatus of claim 11, wherein the controller determines the usage order to minimize blank areas to be padded with padding data to ensure a reproduction compatibility of the information recording medium, such that the information recording medium having a first standard is compatible with a reproduction device of a second standard, different from the first standard.

14. The apparatus of claim 11, wherein the controller controls the writing and/or reading unit to record padding data in blank areas of at least one of the other areas to ensure a reproduction compatibility of the information recording medium, such that the information recording medium having a first standard is compatible with a reproduction device of a second standard, different from the first standard.

15. A recording and/or reproducing apparatus to records and/or to reproduce data to/from an information recording medium having a plurality of areas, the apparatus comprising:
a writing and/or reading unit to record and/or to read the data to/from the information recording medium; and
a controller to control the writing and/or reading unit to move at least one block recorded in at least one first area of the plurality of areas to at least one second area of the plurality of areas, and to record the at least one bock in the at least one second area in order to ensure a reproduction compatibility of the information recording medium such that the information recording medium having a first standard is compatible with a reproduction device of a second standard, different from the first standard.

16. The apparatus of claim 15, wherein the plurality of areas comprises:
one or more replacement areas to store replacement data for user data recorded in a user data area of the information recording medium; and/or
one or more disc management information areas for disc management of the information recording medium.

17. The apparatus of claim 15, wherein:
the plurality of areas comprises a first replacement area and a second replacement area to store replacement data for user data recorded in a user data area of the information recording medium;
the controller controls the writing and/or reading unit to move a replacement block for replacing a data block recorded in the user data area from the first replacement area to the second replacement area; and
the controller further controls the writing and/or reading unit to change replacement information recorded in the information recording medium to reflect the movement of the replacement block.

18. The apparatus of claim 15, wherein the controller receives a command to ensure the reproduction compatibility of the information recording medium from an external control device, or generates the command according to a policy of the apparatus.

19. A recording and/or reproducing apparatus to ensure a reproduction compatibility of an information recording medium having a plurality of areas, the apparatus comprising:
a writing and/or reading unit to record and/or to read data to/from the information recording medium; and
a controller to control the writing and/or reading unit to record and/or read the data to/from the information recording medium, wherein:
the controller receives a command to ensure the reproduction compatibility of the information recording medium from an external control device, or generates the command; and
controls the writing and/or reading unit to move at least one replacement block recorded in at least one first replacement area of the information recording medium to at least one second replacement area in response to the command, to record padding data in blank areas of the at least one second replacement area so that areas containing data are continuous, and to change replacement information recorded in the information recording medium to reflect the movement of the at least one replacement block.

20. A method of ensuring a reproduction compatibility of an information recording medium comprising a user data area to store user data and a plurality of other areas, the method comprising:
determining a usage order of the plurality of other areas according to a location of the user data recorded in the user data area; and
recording data in the plurality of other areas in the determined usage order.

21. The method of claim 20, wherein the plurality of other areas comprises:
one or more replacement areas to store replacement data for the user data recorded in the user data area; and/or
one or more disc management information areas for disc management of the information recording medium.

22. The method of claim 20, wherein the determining of the usage order comprises determining the usage order to minimize blank areas to be padded with padding data to ensure the reproduction compatibility of the information recording medium.

23. The method of claim 20, further comprising recording padding data into blank areas of at least one of the other areas.

24. A method of ensuring a reproduction compatibility of an information recording medium having a plurality of areas, the method comprising:
moving at least one block recorded in at least one first area of the plurality of areas to at least one second area of the plurality of areas in order to ensure the reproduction compatibility of the information recording medium.

25. The method of claim 24, wherein the plurality of areas comprises:
one or more replacement areas to store replacement data for user data recorded in a user data area of the information recording medium; and
one or more disc management information areas for disc management of the information recording medium.

26. The method of claim 24, wherein:
the plurality of areas comprises a first replacement area and a second replacement area to store replacement data for user data recorded in a user data area of the information recording medium;
the moving of the at least one block comprises moving a replacement block for replacing a data block recorded in the user data area from the first replacement area to the second replacement area; and
the method further comprises changing replacement information recorded in the information recording medium to reflect the moving of the replacement block in the information recording medium.

27. The method of claim 24, further comprising:
receiving a command to ensure the reproduction compatibility of the information recording medium from an external control device or generating the command according to a policy of a recording and/or reproducing apparatus.

28. A recording and/or reproducing method for ensuring a reproduction compatibility of an information recording medium having a plurality of areas, the method comprising:
receiving a command to ensure the reproduction compatibility of the information recording medium from an external control device, or generating the command;
moving at least one replacement block recorded in at least one first replacement area of the information recording medium to a second replacement area in response to the command;
recording padding data into blank areas of the second replacement area so that areas containing data are continuous; and
changing replacement information recorded in the information recording medium to reflect the moving of the at least one replacement block in the information recording medium.

29. The information recording medium of claim 1, wherein:
the plurality of other areas comprises a first other area on an inner circumference of the information recording medium and a second other area on an outer circumference of the information recording medium;
the first other area is higher than the second other area in the usage order when the user data is recorded in the user data area from the inner circumference to the outer circumference; and
the second other area is higher than the first other area in the usage order when the user data is recorded in the user data area from the outer circumference to the inner circumference.

30. The information recording medium of claim 5, further comprising a user data area to store user data, wherein:
when the user data is recorded in the user data area from an inner circumference of the information recording medium to an outer circumference of the information recording medium, the at least one first area is on the outer circumference and the at least one second area is on the inner circumference; and
when the user data is recorded in the user data area from the outer circumference of the information recording medium to the inner circumference of the information recording medium, the at least one first area is on the inner circumference and the at least one second area is on the outer circumference.

31. The apparatus of claim 11, wherein:
the plurality of other areas comprises a first other area on an inner circumference of the information recording medium and a second other area on an outer circumference of the information recording medium;
the controller determines the first other area to be higher than the second other area in the usage order when the writing and/or reading unit records the user data in the user data area from the inner circumference to the outer circumference; and
the controller determines the second other area to be higher than the first other area in the usage order when the writing and/or reading unit records the user data in the user data area from the outer circumference to the inner circumference.

32. The apparatus of claim 15, wherein:
the information recording medium further comprises a user data area to store user data;
when the writing and/or reading unit records the user data in the user data area from an inner circumference of the information recording medium to an outer circumference of the information recording medium, the at least one first area is on the outer circumference and the at least one second area is on the inner circumference; and
when the writing and/or reading unit records the user data in the user data area from the outer circumference of the information recording medium to the inner circumference of the information recording medium, the at least one first area is on the inner circumference and the at least one second area is on the outer circumference.

33. The method of claim 20, wherein:
the plurality of other areas comprises a first other area on an inner circumference of the information recording medium and a second other area on an outer circumference of the information recording medium;
and the determining of the usage order comprises:
determining the first other area to be higher than the second other area in the usage order when the user data is recorded in the user data area from the inner circumference to the outer circumference; and
determining the second other area to be higher than the first other area in the usage order when the user data is recorded in the user data area from the outer circumference to the inner circumference.

34. The method of claim 24, wherein:
the information recording medium comprises a user data area to store user data;
when the user data is recorded in the user data area from an inner circumference of the information recording medium to an outer circumference of the information recording medium, the at least one first area is on the outer circumference and the at least one second area is on the inner circumference; and
when the user data is recorded in the user data area from the outer circumference of the information recording medium to the inner circumference of the information recording medium, the at least one first area is on the inner circumference and the at least one second area is on the outer circumference.

35. An information recording medium having a plurality of areas, wherein:
at least one replacement block recorded in at least one first replacement area of the plurality of areas is moved to and recorded in at least one second replacement area of the plurality of areas; and
padding data is recorded in blank areas of the at least one second replacement area so that areas containing data are continuous in order to ensure a reproduction compatibility of the information recording medium; and
replacement information recorded in the information recording medium is changed to reflect the movement of the at least one replacement block.
